(19) United States
(12) Patent Application Publication
(10) Pub. No.: US 2020/0041615 A1
(43) Pub. Date: Feb. 6, 2020

(54) LIDAR DEVICE INCLUDING AT LEAST ONE DIFFUSER ELEMENT

(71) Applicant: Robert Bosch GmbH, Stuttgart (DE)

(72) Inventors: Annette Frederiksen, Renningen (DE); Stefanie Hartmann, Rottenburg Am Neckar (DE)

(21) Appl. No.: 16/525,010

(22) Filed: Jul. 29, 2019

(30) Foreign Application Priority Data
Jul. 31, 2018 (DE) 102018212735.2

(51) Int. Cl. G01S 7/481

(52) U.S. Cl. CPC G01S 7/4814; G02B 5/0252; G01S 7/4815; G01S 7/4813

(57) ABSTRACT

A LIDAR device for scanning a scanning area is described, including a transmitting unit encompassing at least one radiation source for generating electromagnetic beams, encompassing at least one optical transmission system for shaping and emitting the generated electromagnetic beams, and including a receiver unit encompassing an optical receiving system for receiving incoming electromagnetic beams and for deflecting the incoming electromagnetic beams to at least one detector, the transmitting unit and the receiver unit being situated in a housing which is radiation-transparent at least in some areas, the transmitting unit including at least one diffuser element in a beam path of the emitted electromagnetic beams. Moreover, a method for manufacturing a diffuser element for a LIDAR device is provided.

### FIELD OF THE INVENTION

The present invention relates to a LIDAR device for scanning a scanning area and to a method for manufacturing a diffuser element for a LIDAR device.

### BACKGROUND INFORMATION

Typical LIDAR (Light Detection and Ranging) devices are made up of a transmitting unit and a receiver unit. The transmitting unit generates and emits electromagnetic beams continuously or in a pulsed manner. If these beams impact a movable or stationary object, the beams are reflected by the object in the direction of the receiver unit. The receiver unit may detect the reflected electromagnetic radiation and assign a receiver unit to the reflected beams. This may be utilized, for example, within the scope of a “time-of-flight” analysis for an ascertainment of a distance of the object to the LIDAR device.

For LIDAR devices, the range, the resolution, and the scanning area or the so-called field of view are relevant parameters which characterize the performance of LIDAR devices. In particular, the range of a LIDAR device depends mainly on the power of the radiation source. Lasers are frequently utilized as radiation sources. The products including the utilized lasers must be classified according to the IEC standard 60825-1. With respect to eye safety, only the limiting values of Class 1 lasers are considered to be safe with respect to lasers in the infrared wavelength range. This is problematic precisely with respect to applications of LIDAR devices which require a high range. The maximum range of a LIDAR device may be considered to be proportional to the power of the radiation source.

In order for the standard for laser safety to be met, the emitted power of the radiation source must be limited, whereby the range is also limited.

In order to increase the range despite the limited transmission power of the radiation source, the reception aperture of the receiver unit and the detector may be enlarged. As a result, however, the overall size of the LIDAR device is increased. Moreover, the costs for the LIDAR device increase along with an enlargement of the reception aperture and of the detector.

### SUMMARY

An object underlying the present invention may be considered that of providing an eye-safe LIDAR device having an enlarged range and an unchanged overall installation space.

According to one aspect of the present invention, a LIDAR device for scanning a scanning area is provided. The LIDAR device includes a transmitting unit encompassing at least one radiation source for generating electromagnetic beams, encompassing at least one optical transmission system for shaping and emitting the generated electromagnetic beams. Moreover, the LIDAR device includes a receiver unit encompassing an optical receiving system for receiving incoming electromagnetic beams and for deflecting the incoming electromagnetic beams to at least one detector, the transmitting unit and the receiver unit being situated in a housing which is radiation-transparent at least in some areas. According to the present invention, the transmitting unit includes at least one diffuser element in a beam path of the emitted electromagnetic beams.

An important parameter for eye safety is an extension of the apparent source or of the generated beam in the form of a generated spot size on the retina of an eye. The greater this extension is, the higher a transmission power of the radiation source may be selected to be, since the generated beam is imaged on the retina on a larger area. When taking eye safety into account, an adaptation of the eye must be incorporated into the considerations. The adaptation of the eye may result in different images of the generated beams on the retina. A focal range of the eye between 10 cm and infinity may be assumed in this case. A focusing of the eye on 10 cm corresponds to a focal length of the eye, converted in air, of 14.5 mm; in the case of an adaptation of the eye to infinity, the focal length of the eye is 17 mm.

The idea of the present invention is that of introducing a diffuser element on the transmission side, which diffuses the emitted power of the radiation source in a desired solid angle or scanning area and, therefore, increases eye safety. In particular, eye safety may be increased due to the fact that the planar extension of the radiation source imaged on the retina of the eye is enlarged due to the introduction of a diffuser element, and the power per unit area is reduced. The utilized diffuser elements are designed, in this case, in such a way that the road-side divergence angle of the emitted radiation is identical to that of a conventionally designed system, i.e., the diffuser diffuses only in a small angular range. Therefore, the retinal images are also identical in the case of adaptation to a first plane, which corresponds to the plane of the diffuser element. When the beams are virtually extended into the device, however, a larger angular range is covered, whereby larger retinal images result upon adaptation to a second plane (see FIGS. 2 and 3) and an imaging of the beam waist on the retina is no longer possible.

The LIDAR device may preferably have a high range. The radiation source may include one or multiple lasers or LEDs and, for example, generate electromagnetic beams in the infrared or ultraviolet wavelength range for scanning the scanning area. Due to the at least one diffuser element situated in the beam path of the transmitting unit, the transmission power may be increased while retaining an overall size of the LIDAR device and a divergence of the emitted beams. In particular, the at least one diffuser element may be designed as a film, a coating, an element mountable onto the optical transmission system, and the like.

There is preferably a defined beam exit area at the beam outlet of the housing of the LIDAR device. This beam exit area may remain unchanged. As a result, the diffuser element is also suitable for use as a retrofitting approach for existing LIDAR devices. Due to the utilization of the at least one diffuser element, the divergence angle or the angle of the emitted beams is not generated via a shaping of a Gaussian beam with the aid of optical systems, but rather via diffusion on the diffuser element in the defined angular range.

Due to the utilization of multiple diffuser elements or diffuser elements having locally adapted optical properties, different vertical angular ranges may be implemented in different scanning areas in the case of a rotating or scanning LIDAR device. For example, the vertical angular ranges may be 0°, 15°, and 24°. As a result, edges of the LIDAR device may be scanned at another vertical angle, as a front area or a rear area of the LIDAR device.

Due to the utilization of the at least one diffuser element, the eye safety of the LIDAR device may be increased or, in the case of increasing power of the radiation source, may remain unchanged. Since the at least one diffuser element may be compactly designed and situated in the transmitting unit, the overall installation space of the LIDAR device is not enlarged as a result.

According to one exemplary embodiment, the diffuser element has a planar or a non-planar shape. As a result, the diffuser element may be mounted onto a planar surface or onto a curved surface. In particular, an existing surface, such as an outer surface of a final lens of the transmitting unit or of the optical transmission system, may be utilized as a mounting surface for the diffuser element. In this case, the diffuser element, for example, in the case of a rotating LIDAR device, would rotate along with the transmitting unit and would always be located in the beam path of the emitted beams. In biaxial systems, the transmission path and the reception path are separated from one another, so that a diffuser element arranged in such a way does not cause an interruption in the reception path.

According to a further specific embodiment, the diffuser element has an oblique inclination angle in relation to the optical transmission system or is aligned essentially orthogonally with respect to the optical transmission system. The arrangement of the diffuser element may therefore be designed to be particularly flexible. Obliquely positioned or curved diffuser elements may be utilized. In particular, the surface of the diffuser element may be formed to be planar or non-planar. As a result, a simple adaptation of the diffuser element to arbitrary emitted beams may be carried out, whereby the optical transmission system may be designed to be simpler and more economical.

According to a further specific embodiment, the transmitting unit and the receiver unit are arranged one above the other in the vertical direction and a radiation-transparent section of the housing is designed, at least in some areas, as a diffuser element. Alternatively, the diffuser element may be situated next to or on the radiation-transparent section of the housing and conceal the radiation-transparent section, at least in some areas. In this case, the diffuser element may conceal an area of a radiation-transparent section of the housing. Preferably, only an area located in a beam path of the emitted beams is concealed. As a result, the at least one diffuser element may be designed to be stationary and, for example, mounted on the housing in the direction of rotation above a radiation-transparent area for incoming beams or beams reflected in the scanning area. Therefore, interruptions of receiving functions of the LIDAR device may be avoided.

According to a further specific embodiment of the LIDAR device, the diffuser element is a volume hologram. As a result, the diffuser element may be designed as a diffractive optical element. In contrast to conventional optical systems, in the case of such holographic optical elements which are implemented as volume holograms, the beam deflection is not predefined by refraction, but rather by diffraction on at least one volume grating. The holographical optical elements may be produced in transmission as well as in reflectance and they make new designs possible due to the free selection of the angle of entry, the emergence angle, and the diffraction angle. The holographic diffraction grating may be preferably exposed into a thin film.

Due to the volume diffraction, the diffuser element may additionally have a characteristic wavelength and angle selectivity or filter functions. Depending on the recording condition (wavelength, angle), as a result, only light from defined directions and having defined wavelengths may be diffracted on the structure of the diffuser element and, therefore, transmitted. As a result, the holographic material applied onto a film is distinguished, in particular, by its transparency. Only light from certain directions and wavelengths is diffracted on the structure. For all other directions, the hologram remains transparent.

Moreover, a high diffraction efficiency and a high cost efficiency may be achieved with the aid of the volume hologram. Due to a low thermal influence of the diffusion function, diffuser elements designed in this way may be particularly robust and reliable within a wide temperature range.

According to a further specific embodiment, the diffuser element designed as a volume hologram has at least two optical functions. The surface or the volume of the diffuser element may have at least two superimposed optical functions. As a result, the diffuser element may simultaneously fulfill multiple optical functions which, for example, are dependent on the emitted beams. In addition to deflection and diffusion, filter functions or focusing, for example, may also be implemented with the aid thereof. Consequently, imaging errors may also be corrected with the aid of the design of the diffuser element.

According to a further exemplary embodiment, at least one optical function is an angle-of-entry selectivity or a wavelength selectivity. For example, the diffuser element designed as a volume hologram may implement different diffusion functions for different wavelengths, such as 905 nm, 920 nm, and 940 nm. Therefore, it is possible to adapt the field of view of the LIDAR device via the activation of radiation sources having generated beams of different wavelengths. For example, in the case of such a LIDAR device according to the present invention including slit illumination, the vertical extension of the slit could be changed depending on which radiation source is switched on. Alternatively, the alignment of the slit in the vertical direction would also be adaptively regulatable. Therefore, a flexible and situation-dependent scanning of the scanning area, for example during travel uphill and downhill, may take place.

According to a further specific embodiment, the electromagnetic beams which have been emitted and have been transmitted by the diffuser element are selectively diffusible with the aid of at least one optical function of the diffuser element. Therefore, differently formed beams may be diffused to different extents. The different beams may have, for example, different wavelengths, different polarization directions, or different angles of entry onto the diffuser element.

According to a further specific embodiment, the electromagnetic beams which have been emitted and have been transmitted by the diffuser element are selectively diffusible with the aid of at least one optical function of the diffuser element along a vertical scanning angle and/or along a horizontal scanning angle. Preferably, a vertical and/or horizontal angle of diffusion may be controlled, depending on the optical properties of the beams impacting the diffuser element. It is therefore technically easily possible to carry out an active control or adaptation of the scanning area. All that is required for this purpose are multiple radiation sources or a manipulator for the beams generated by a radiation source.

When multiple radiation sources are utilized, the generated beams may be coupled into the optical transmission system, for example, by utilizing a dichroic filter or a mirror, and therefore impact the same areas of the holographic diffuser element. Since the diffuser element has different stored functions for different wavelengths, it is therefore possible to change the emerging beam in a selective or targeted manner. Due to a sequential activation of multiple radiation sources, it is possible, for example, to operate with the aid of different vertical scanning angles. This control of the radiation sources may also be utilized for a horizontal scanning angle or divergence angle.

According to a further embodiment, the transmitting unit includes at least one retardation plate for adapting a polarization of generated or emitted electromagnetic beams. In this case, the at least one optical function of the diffuser element is preferably dependent on the polarization of the transmitted electromagnetic beams.

Instead of or in addition to a utilization of various radiation sources having different wavelengths, one radiation source may be utilized. The separation of the holographic function does not take place or does not exclusively take place, in this case, on the basis of the wavelength, but rather on the basis of the polarization of the beams. Polarization-dependent holograms may be utilized for this purpose. Due to a recording with the aid of two reference waves, each having crossed polarization, and an object wave which has only one of the two polarization directions, the polarization information of the object is now obtained. Therefore, in the subsequent reconstruction, the hologram will also be optically effective for only one polarization direction, while the other polarization direction is not influenced by the hologram. The hologram or the holographic diffuser element may act comparably to a lens and/or a deflector for a certain polarization direction. In this case, the incoming beams are influenced by diffraction on the diffuser element. Such a polarization-dependent diffuser element may be made of a photo-anisotropic material. Due to its special structure, the diffuser element may have a polarization-dependent diffraction. The advantage of this variant is that only one radiation source is necessary. In an alternative embodiment, two or more radiation sources may also be utilized for generating differently polarized beams, so that the polarization element or the retardation plate may be dispensed with. An active control of multiple radiation sources may also be dispensed with. The polarization of the generated beams may be rotated in order to activate multiple diffusion functions. The adjustment of the polarization of the generated beams may be achieved, for example, with the aid of a switchable small retardation plate.

According to a further specific embodiment, the transmitting unit includes at least two radiation sources which are coupleable into the optical transmission system directly, with the aid of a dichroic filter, or with the aid of at least one mirror. As a result, the radiation sources may be arbitrarily arranged in the LIDAR device. The generated beams may be flexibly coupled into the optical transmission system and adapted to the geometric conditions and limiting conditions.

According to a further aspect of the present invention, a method is provided for manufacturing a diffuser element for a LIDAR device according to the present invention. In a first step, a light-sensitive holographic material is made available. At least one optical grating for forming the diffuser element is generated into or onto the light-sensitive holographic material with the aid of at least one exposure and storage of at least one interference pattern on or in the light-sensitive holographic material.

The holographic diffuser element may be stored or exposed into a light-sensitive holographic material in this case. The holographic material may be, for example, a photopolymer, a silver halide, or the like. Due to the storage of an interference pattern in the light-sensitive material, at least one optical grating is generated. The storage may be carried out in a material-dependent manner, such as with the aid of a wet-chemical process or via UV exposure.

According to one specific embodiment of the method, the light-sensitive holographic material is exposed with the aid of a diffuser. Therefore, a template may be provided for reproducibly manufacturing diffuser elements having consistent optical functions. As a result, the diffuser element is cost-effectively manufacturable.

According to a further specific embodiment of the method, the light-sensitive holographic material is exposed completely, in some areas, or pixel by pixel in order to generate optical gratings. The diffuser elements or the diffuser holograms may be recorded in an analog or printed manner in this case. In the case of analog recording, the hologram is exposed over a large area. The resultant divergence angle of the diffuser element is predefined by the diffuser utilized for the recording. In particular, the divergence angle is defined by the positioning of the reference wave and the object wave during the hologram recording.

Due to the free positioning of the two waves during the hologram recording, arbitrary diffraction angles and divergence angles may be generated. In contrast to conventional diffusers, a higher level of design freedom may therefore be achieved. In particular, so-called off-axis geometries may also be implemented. In addition, volume holograms may also be generated in transmission and in reflectance and may be utilized in a LIDAR device according to the present invention.

Moreover, the holographic diffuser elements may also be printed pixel by pixel. As compared to the previously described analog recording, this has the advantage that the diffuser angle or the divergence angle is predefined by a phase pattern on a phase shifting element, such as a spatial light modulator, and this may be exposed pixel by pixel into the holographic material. The particular pixels are exposed segment by segment in this case. As a result, phase patterns may be predefined not only for real objects. Reference waves as well as object waves may be manipulated and may be adapted to the particular application in a spatially separated manner. The pixel size may also be adapted to an application in this case. For example, a square pixel may have a side length of up to 100 μm. In the case of holograms printed pixel by pixel, a different optical function may be stored into the holographic material in a spatially resolved manner. A diffuser element manufactured in this way may be subdivided into areas having a greater resolution and areas having a lower resolution.

The diffuser elements according to the present invention may be utilized in so-called scanning, micromirror-based LIDAR devices as well as in rotating LIDAR devices. An angle of the reference wave or the divergence angle may be preferably adapted to a scanning angle of the micromirror.

### BRIEF DESCRIPTION OF THE DRAWINGS

FIG. 1A shows a comparison between a conventional beam shaping and a beam shaping with the aid of a diffuser element according to the present invention.

FIG. 1B shows a comparison between a conventional beam shaping and a beam shaping with the aid of a diffuser element according to the present invention.

FIG. 2 shows a side view for illustrating beam paths having two adaptation planes.

FIG. 3A shows a first exemplary image on a retina of an eye.

FIG. 3B shows a second exemplary image on a retina of an eye.

FIG. 3C shows a third exemplary image on a retina of an eye.

FIG. 3D shows a fourth exemplary image on a retina of an eye.

FIG. 4 shows a top view of a LIDAR device according to a first specific embodiment of the present invention.

FIG. 5 shows a top view of a LIDAR device according to a second specific embodiment of the present invention.

FIG. 6 shows a top view of a LIDAR device according to a third specific embodiment of the present invention.

FIG. 7 shows a top view of a LIDAR device according to a fourth specific embodiment of the present invention.

FIG. 8 shows a top view of a LIDAR device according to a fifth specific embodiment of the present invention.

FIG. 9 shows a side view of a LIDAR device according to the fifth specific embodiment of the present invention.

FIG. 10 shows representations for illustrating a method for manufacturing a diffuser element according to a specific embodiment of the present invention.

FIG. 11 shows representations for illustrating a method for manufacturing a diffuser element according to a further specific embodiment of the present invention.

FIG. 12 shows schematic diagrams for illustrating a wavelength selectivity and an angle selectivity of a diffuser element.

### DETAILED DESCRIPTION

In the figures, the same structural elements each have the same reference numerals.

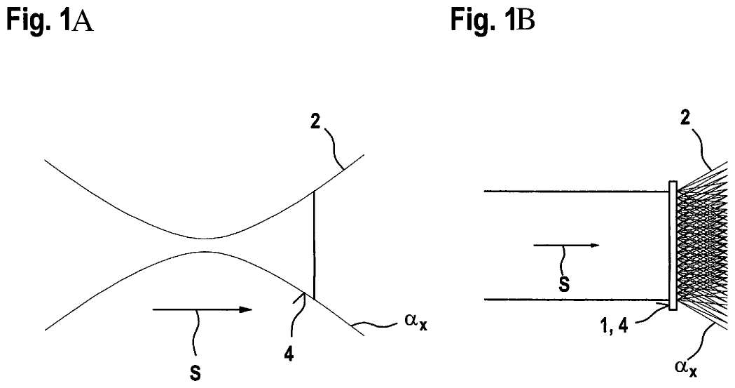

FIG. 1 shows a comparison between a conventional beam shaping and a beam shaping with the aid of a diffuser element 1 according to the present invention. A course of emitted beams 2 is represented along a vertical orientation. FIG. 1A shows a conventional beam shaping which is compared, in FIG. 1B, to a beam shaping with the aid of diffuser element 1 according to the present invention.

The two systems have identical beam exit areas 4 and identical divergence angles or vertical scanning angles dₓ. The beam shaping represented in FIG. 1B with the aid of diffuser element 1 according to the present invention is more flexible with respect to the phase front or emitted beams 2 before beam exit area 4, since a diffuser element 1 may be flexibly adapted. This is illustrated, in particular, by way of the fact that a parallel beam is usable in beam direction S before diffuser element 1, in contrast to FIG. 1A. The phase front before diffuser element 1 is not limited to a parallel beam. For example, the phase front may impact diffuser element 1 obliquely, divergently, convergently, and the like, before an emission into a scanning area.

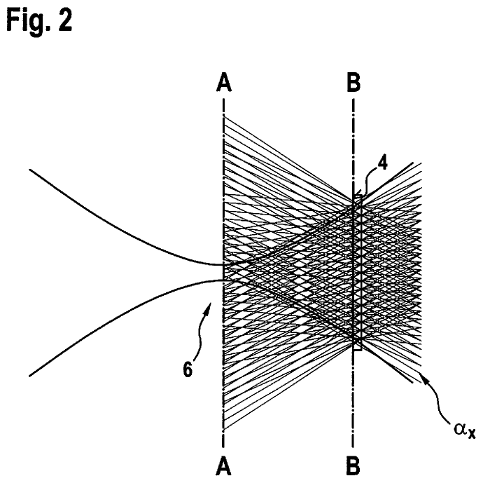

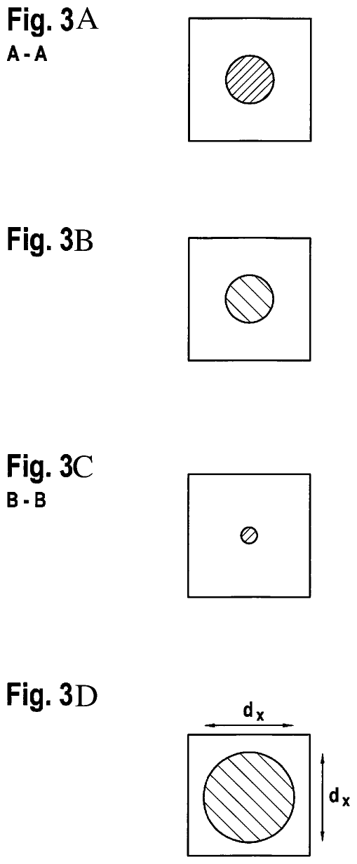

FIG. 2 shows the beam shapings represented in FIG. 1 in a superimposed representation. As a result, identical beam exit areas 4 and identical vertical scanning angles dₓ are illustrated. In particular, two planes A-A and B-B are defined for illustrating the differences between the beam shapings illustrated in FIG. 1A and FIG. 1B. Planes A-A and B-B represent two exemplary adaptation planes which are depictable in an eye. For this purpose, FIGS. 3A-3D show exemplary images on a retina of an eye.

When a human eye is located in the illuminated beam cone illuminated with the aid of emitted beams 2 and looks into a sensor and adapts to beam exit area 4 and plane B-B, the spot generated on the retina is of the same size. This comparison is shown in FIGS. 3A and 3B.

In the case of the adaptation to the plane A-A, a considerable difference is visible, which arises from FIGS. 3C and 3D. The conventional system (FIG. 3C) results in a very small retinal spot size, since beam waist 6 is imaged. In a system including diffuser element 1, the beams are virtually represented extended up to plane A-A. If the apparent source now located here is imaged, a considerably larger retinal spot size results (FIG. 3D). Due to the beam cone, which has been designed to be larger, a higher transmission power may be utilized while complying with the standards for eye safety.

For the sake of simplicity, an identical behavior in different extension directions was assumed in the representation of the retinal images in FIGS. 3A-3D; the illumination may be different at different horizontal scanning angles d_{y} and vertical scanning angles dₓ.

Horizontal scanning angle d_{y} and vertical scanning angle dₓ cover a scanning area. With respect to the retinal images represented in FIGS. 3A-3D, the size of the circle is the illuminated area on the retina. The section defined in the rectangle corresponds to a section covered by horizontal scanning angle d_{y} and vertical scanning angle dₓ. Assuming the above-described model, the angle by which this retinal area is covered, as viewed from the crystalline lens, may be calculated on the basis of these longitudinal extensions, whereby angular subtenses αₓ and α_{y} of the apparent source are then obtained.

In the evaluation of a laser system with respect to eye safety, angular subtenses αₓ and α_{y} of the apparent source must be ascertained according to IEC standard 60825-1. This results from the retinal spot size. A larger retinal spot size results in a greater angular subtense which, in turn, results in a greater correction factor C₆. Correction factor C₆ is calculated from the ascertained angular subtense divided by 1.5 mrad, the ascertained angular subtense corresponding to (αₓ+α_{y})/(2). Correction factor C₆, in turn, is linearly incorporated into the limiting values. Therefore, a greater C₆ factor permits more power for the same laser class. This greater C₆ may be achieved by utilizing a diffuser element 1.

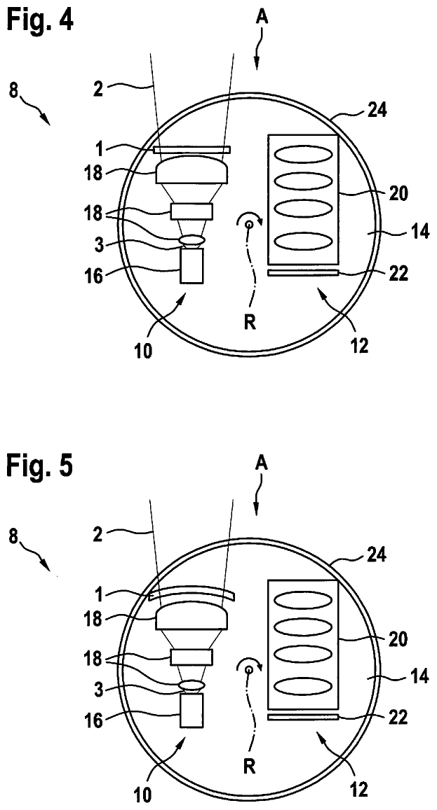

Illustrated in FIG. 4 is a top view of a LIDAR device 8 according to a first specific embodiment of the present invention. LIDAR device 8 is designed as a rotating LIDAR device 8. In particular, LIDAR device 8 is biaxially designed, whereby a transmitting unit 10 and a receiver unit 12 are decoupled from one another or utilize different beam paths. LIDAR device 8 is positioned on a rotatable plate 14, whereby transmitting unit 10 and receiver unit 12 are rotated jointly at a defined rotational speed. Plate 14 rotates about a rotational axis R, whereby a horizontal scanning angle d_{y} of 360° is implementable. Alternatively, LIDAR device 8 may be equipped with a so-called scanning or swivelable mirror for deflecting emitted beams 2 into a scanning area A.

Transmitting unit 10 of LIDAR device 8 includes a radiation source 16. According to the exemplary embodiment, radiation source 16 is a laser 16 for generating beams 3. Generated beams 3 are coupled into an optical transmission system 18. Optical transmission system 18 is designed in such a way that a desirable divergence of emitted beams 2 is achieved. The divergence set here does not need to match the desired divergence of the system, however, but rather must achieve the desired system divergence in interaction with the optical function of the holographic diffuser element. Preferably, the divergence of emitted beams 2 may be selected in such a way that the extension of diffuser element 1 is completely illuminated. Optical transmission system 18 is made up of an optical system encompassing three lenses in this case, by way of example. After the shaping of generated beams 3 by optical transmission system 18, emitted beams 2 are radiated outward with the aid of diffuser element 1 into scanning area A.

Beams reflected in the scanning area may be received by an optical receiving system 20 and directed to a detector 22. Optical receiving system 20 may be made up of an imaging lens, for example, which collects the light reflected back by the surroundings with the aid of a reception aperture. Detector 22 may be, for example, an APD (avalanche photodiode) detector or a SPAD (single-photon avalanche diode) detector. Moreover, detector 22 may also be designed as a detector array.

Transmitting unit 10 and receiver unit 12 situated on rotating plate 14 are situated in a housing 24 of LIDAR device 8, protected against environmental influences. Housing 24 is stationarily situated relative to rotating plate 14.

According to the exemplary embodiment, diffuser element 1 is designed as a flat plate which is situated in the beam path of emitted beams 2 between housing 24 and optical transmission system 18.

FIG. 5 shows a top view of a LIDAR device 8 according to a second specific embodiment of the present invention. In contrast to the example shown in FIG. 4, diffuser element 1 is designed to be rounded or curved. In particular, diffuser element 1 may have a contour which corresponds to a contour of a final lens of optical transmission system 18. For example, diffuser element 1 may be situated on optical transmission system 18 or may be designed as a coating of optical transmission system 18.

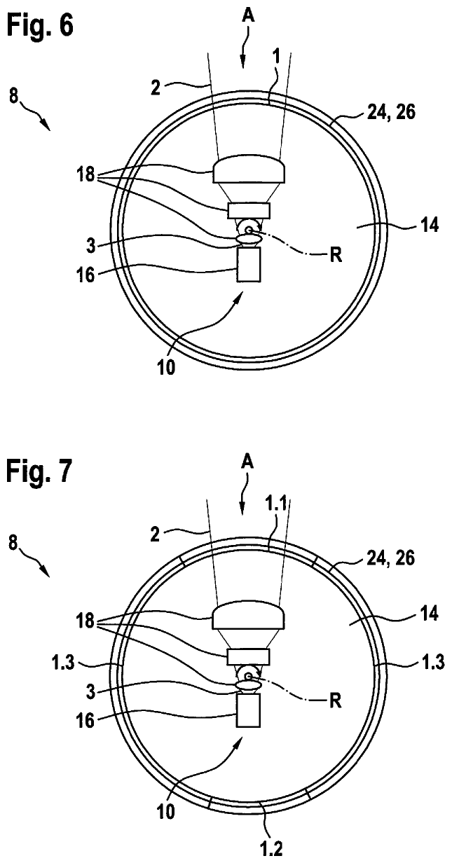

FIG. 6 shows a top view of a LIDAR device 8 according to a third specific embodiment of the present invention. In contrast to the above-described examples, diffuser element 1 is mounted on stationary or fixed housing 24 in this case. In particular, housing 24 includes a radiation-transparent area 26 which is utilized as a window for emitted beams 2 and beams reflected from scanning area A. Transmitting unit 10 and receiver unit 12 are situated one above the other in this case, in the vertical direction or in the direction of rotational axis R, whereby a portion of radiation-transparent section 26 is not covered by diffuser element 1. Diffuser element 1 is fixedly situated on an inside of housing 24 and fixed to housing 24 in this case. Preferably, diffuser element 1 is designed as a film and is fixedly positioned on the inside of radiation-transparent area 26 of housing 24. The area including installed diffuser element 1 may preferably extend parallel to a radiation-transparent area 26 without a diffuser element 1 for the reflected beams. As a result, receiver unit 12 may remain unchanged.

FIG. 7 shows a top view of a LIDAR device 8 according to a fourth specific embodiment of the present invention. In contrast to the exemplary embodiment shown in FIG. 6, diffuser element 1 is subdivided into multiple sections 1.1, 1.2, 1.3 or multiple diffuser elements 1.1, 1.2, 1.3. In particular, particular diffuser elements 1.1, 1.2, 1.3 may have different optical functions. For example, sections 1.3 of the edges of LIDAR device 8 may include a smaller vertical scanning area αₓ than sections 1.1 of the front and section 1.2 of the back of LIDAR device 8.

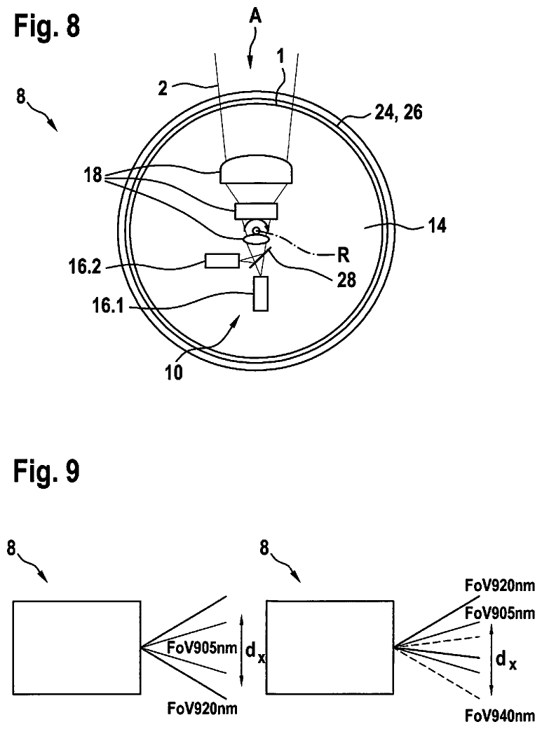

FIG. 8 illustrates, in a top view, a LIDAR device 8 according to a fifth specific embodiment of the present invention. In contrast to the above-described examples, LIDAR device 8 includes multiple radiation sources 16.1, 16.2. The beams generated with the aid of radiation sources 16.1, 16.2 have different wavelengths.

Due to a characteristic angle and wavelength selectivity of diffuser element 1, a crosstalk of the individual optical functions may be avoided. The selectivity is influenced by the parameters of the holographic material (thickness d and refractive index modulation).

Due to the two exemplary radiation sources 16.1, 16.2, emitted beams 2 having two different wavelengths may be generated. Due to the wavelength selectivity of diffuser element 1, the beams of particular radiation sources 16.1, 16.2 may therefore be diffused on diffuser element 1 to considerably different extents. As a result, a wavelength-dependent, vertical and horizontal divergence angle or scanning area αₓ, α_{y} may be implemented.

The two radiation sources 16.1, 16.2 may be coupled into optical transmission system 18 via the utilization of a dichroic filter or a mirror 28. Preferably, the beams of both radiation sources 16.1, 16.2 coupled into optical transmission system 18 may impact an identical area of holographic diffuser element 1.

Vertical scanning angles dₓ and/or horizontal scanning angles d_{y} may be adapted by sequentially activating radiation sources 16.1, 16.2.

In FIG. 9, LIDAR device 8 from FIG. 8 is represented in a side view according to the fifth specific embodiment of the present invention. In particular, vertical scanning angles dₓ are illustrated for beams having different wavelengths. The particular scanning angles or field of view are shown at the exemplary wavelengths of 905 nm, 920 nm, and 940 nm.

It is therefore possible to adapt scanning angles dₓ, d_{y} of LIDAR device 8 by activating radiation sources 16.1, 16.2. For example, in the case of a LIDAR device having a slit illumination, vertical extension αₓ of the slit may be adapted (left side), depending on which radiation source 16.1, 16.2 is switched on. Alternatively or additionally, the orientation of the slit in the horizontal direction is also adaptively regulatable (right side), for example, during travel uphill or downhill.

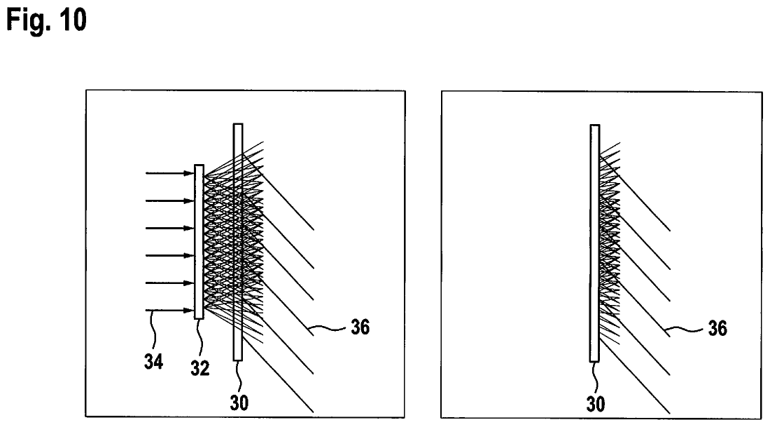

FIG. 10 shows representations for illustrating a method for manufacturing a diffuser element 1 according to a specific embodiment of the present invention.

A light-sensitive, holographic material 30 is provided. Light-sensitive, holographic material 30 may be formed, for example, as a plate or a film.

A diffuser 32 is positioned as a mask next to light-sensitive, holographic material 30. Thereafter, an object wave 34 is applied to light-sensitive, holographic material 30 from a direction of diffuser 32 and a reference wave 36 is applied to light-sensitive, holographic material 30 from an opposite direction. As a result, at least one optical grating for forming diffuser element 1 may be generated into or onto light-sensitive holographic material 30 with the aid of at least one exposure and storage of at least one interference pattern on or in light-sensitive holographic material 30.

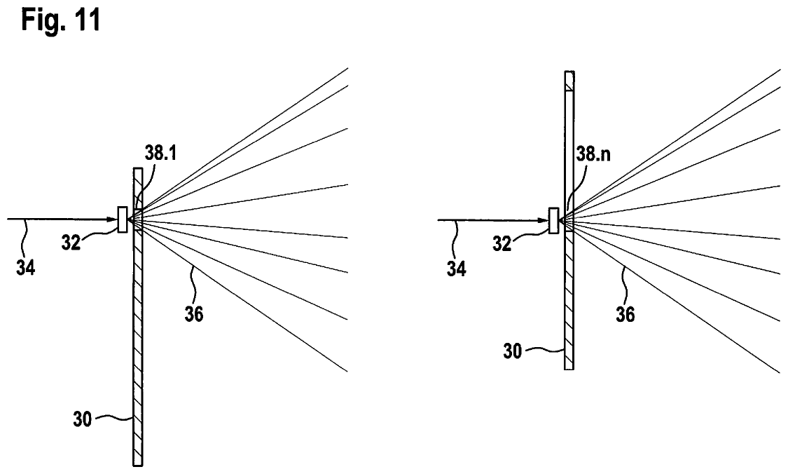

FIG. 11 shows representations for illustrating a method for manufacturing a diffuser element 1 according to a further specific embodiment of the present invention. In contrast to FIG. 10, light-sensitive, holographic material 30 is exposed pixel by pixel. Particular pixels 38.1 through 38.n are provided with optical functions, one after the other.

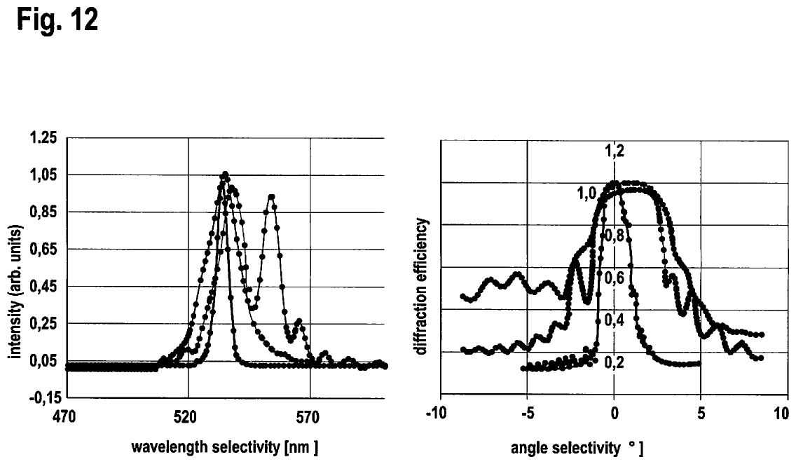

FIG. 12 shows schematic diagrams for illustrating a wavelength selectivity and an angle selectivity of a diffuser element 1 designed as a volume hologram. The particular wavelengths may be, for example, in the infrared, visible, or ultraviolet range. The wavelengths are preferably situated so far apart from one another that the individual optical functions may be clearly separated from one another. Three optical gratings are written into holographic material 30, by way of example. In addition, the wavelength and angle selectivity of volume holograms depending on material parameters is represented in FIG. 12, and these have been optimized (from standard to first and final), whereby the wavelength and angle selectivity may be improved. In the reconstruction of the structure with the aid of three lasers 16 from the same reconstruction angle (at different wavelengths), emitted beams 2 may be diffracted on diffuser element 1 with the aid of the same diffusion function. The wavelengths may be selected in such a way that they may nevertheless be detected by detector 22. This may be advantageous with respect to eye safety when the wavelength ranges lie far enough apart from one another, such as 905 nm and 1550 nm. The resultant angle of dispersion is dependent on the wavelengths of emitted beams 2.

What is claimed is:

1. A LIDAR device for scanning a scanning area, comprising:
a transmitting unit including:
at least one radiation source for generating an electromagnetic beam, and
at least one optical transmission system for shaping and emitting the generated electromagnetic beam;
at least one detector;
a receiver unit including an optical receiving system for receiving an incoming electromagnetic beam and for deflecting the incoming electromagnetic beam to the at least one detector; and
a housing within which the transmitting unit and the receiver unit are situated, wherein:
the housing is radiation-transparent at least in some areas, and
the transmitting unit includes at least one diffuser element in a beam path of the emitted electromagnetic beam.

2. The LIDAR device as recited in claim 1, wherein the diffuser element has one of a planar shape and a non-planar shape.

3. The LIDAR device as recited in claim 1, wherein the diffuser element one of:
has an oblique inclination angle in relation to the optical transmission system, and
is aligned essentially orthogonally with respect to the optical transmission system.

4. The LIDAR device as recited in claim 1, wherein the transmitting unit and the receiver unit are situated one above the other in a vertical direction, and wherein one of:
a radiation-transparent section of the housing is the diffuser element, at least in some sections, and
the diffuser element is situated one of next to and on the radiation-transparent section of the housing and conceals the radiation-transparent section, at least in some sections.

5. The LIDAR device as recited in claim 1, wherein the diffuser element is a volume hologram.

6. The LIDAR device as recited in claim 5, wherein the diffuser element is volume hologram having at least two optical functions.

7. The LIDAR device as recited in claim 6, wherein at least one of the optical functions is one of an angle-of-entry selectivity and a wavelength selectivity.

8. The LIDAR device as recited in claim 6, wherein the electromagnetic beam that has been emitted and has been transmitted by the diffuser element is selectively diffusible with the aid of at least one of the optical functions of the diffuser element.

9. The LIDAR device as recited in claim 6, wherein the electromagnetic beam that has been emitted and has been transmitted by the diffuser element is selectively diffusible with the aid of at least one of the optical functions of the diffuser element along at least one of a vertical scanning angle and a horizontal scanning angle.

10. The LIDAR device as recited in claim 6, wherein:
the transmitting unit includes at least one retardation plate for adapting a polarization of one of the generated electromagnetic beam and the emitted electromagnetic beam, and
at least one of the optical functions of the diffuser element is dependent on the polarization of the transmitted electromagnetic beam.

11. The LIDAR device as recited in claim 1, wherein the transmitting unit includes at least two radiation sources that are coupleable into the optical transmission system directly, with the aid of one of a dichroic filter and at least one mirror.

12. A method for manufacturing a diffuser element for a LIDAR device for scanning a scanning area, the LIDAR device including a transmitting unit that includes at least one radiation source for generating an electromagnetic beam, and at least one optical transmission system for shaping and emitting the generated electromagnetic beam, the LIDAR device including at least one detector, the LIDAR device including a receiver unit that includes an optical receiving system for receiving an incoming electromagnetic beam and for deflecting the incoming electromagnetic beam to the at least one detector, and the LIDAR device including a housing within which the transmitting unit and the receiver unit are situated, wherein the housing is radiation-transparent at least in some areas, and wherein the transmitting unit includes at least one diffuser element in a beam path of the emitted electromagnetic beam, the method comprising:
providing a light-sensitive, holographic material; and
generating at least one optical grating for forming the diffuser element one of into and onto the light-sensitive holographic material with the aid of at least one exposure and storage of at least one interference pattern one of on and in the light-sensitive holographic material.

13. The method as recited in claim 12, further comprising exposing the light-sensitive holographic material with the aid of the diffuser element.

14. The method as recited in claim 12, further comprising exposing completely the light-sensitive holographic material one of in some areas and pixel by pixel in order to generate optical gratings.
